(19) United States
(12) Patent Application Publication
(10) Pub. No.: US 2013/0215431 A1
(43) Pub. Date: Aug. 22, 2013

(54) OPTICAL COHERENCE TOMOGRAPHY SYSTEM AND METHOD THEREFOR

(71) Applicant: The Board of Trustees of the Leland Stanford Junior University, (US)

(72) Inventor: Audrey Ellerbee, Stanford, CA (US)

(73) Assignee: The Board of Trustees of the Leland Stanford Junior University, Palo Alto, CA (US)

(21) Appl. No.: 13/828,009

(22) Filed: Mar. 14, 2013

Related U.S. Application Data
(63) Continuation-in-part of application No. 13/160,879, filed on Jun. 15, 2011, now Pat. No. 8,446,593.
(60) Provisional application No. 61/355,248, filed on Jun. 16, 2010.

(51) Int. Cl. G01B 9/02

(52) U.S. Cl. CPC G01B 9/02091
USPC 356/479

(57) ABSTRACT

A method for increasing the imaging rate for an optical coherence tomography system is disclosed. The method comprises generating an interferometric signal by interrogating each of M object points on a sample with a unique set of wavelength components that are collectively spectrally interleaved within a spectral range, forming the interferometric signal based on the wavelength components reflected from the interrogated object points, dispersing the interferometric signal across a two-dimensional array of detectors, and forming an image based on the dispersed spectral components.

### CROSS REFERENCE TO RELATED APPLICATIONS

This case is a continuation-in-part of co-pending U.S. patent application Ser. No. 13/160,879, filed Jun. 15, 2011, entitled “Optical Coherence Tomography System and Method Therefor” (Attorney Docket: 146-026US), which claims the benefit of U.S. Provisional Patent Application Ser. No. 61/355,248, filed Jun. 16, 2010, entitled “A Spectral Encoding-based Approach to Real-time Volumetric Imaging with Optical Coherence Tomography,” each of which is incorporated herein by reference.

If there are any contradictions or inconsistencies in language between this application and one or more of the cases that have been incorporated by reference that might affect the interpretation of the claims in this case, the claims in this case should be interpreted to be consistent with the language in this case.

### FIELD OF THE INVENTION

The present invention relates to optical coherence tomography in general, and, more particularly, to spectral-domain optical coherence tomography.

### BACKGROUND OF THE INVENTION

Optical coherence tomography (OCT) has become an increasingly popular diagnostic tool in areas such as the biological, biomedical, medical screening, and vision-care. It utilizes low-coherence optical interferometry to enable non-invasive imaging of micron-scale microstructure inside biological tissue. In recent years, OCT has rapidly become competitive with radiography, ultrasound and magnetic resonance imaging in the biological and biomedical imaging communities due, in part, to its relatively low cost and high-resolution, in-vivo capabilities, as well as its lack of ionizing radiation. In the vision-care arena, for example, OCT is used to non-invasively image the human eye fundus, thereby facilitating diagnosis of retinal pathologies, such as macular degeneration, glaucoma, retinitous pigmentosa, and the like.

Early OCT systems were typically time-domain systems based on a relatively simple implementation of the classic Michelson interferometer. In such an interferometer, an input light signal is split into a reference arm and a sample arm. In the reference arm, light is directed toward a movable reference mirror, which continuously reflects light back toward the detector. The length of the reference arm depends on the position of this mirror. In the sample arm, light is directed at an object point of a sample under test and only light reflected by sub-surface features in the sample is returned toward the detector. The length of the sample arm, therefore, is based on the positions of features within the sample tissue. A beam combiner combines the two reflected light signals to form an interferometric signal that generates an interference pattern at a detector. Light that travels the same length in each of the reference arm and sample arm constructively recombines to form high-intensity signals at the detector.

A one-dimensional scan of the surface and sub-surface features of the object point (commonly referred to as an “A-scan”) is developed by scanning the reference mirror at a constant speed to change the length of the reference arm. This encodes the depths of the surface and sub-surface features in time based on the position of the reference mirror, as represented in the interference pattern that is subsequently sampled by the detector. A two-dimensional scan of the sample (commonly referrer to as a “B-scan”) is produced by sequentially performing a series of A-scans, each at a different object point along a line on the sample.

Unfortunately, while early time-domain OCT techniques were promising, their complexity and time-intensive nature served to limit their widespread adoption.

The advent of Fourier-domain OCT (FD-OCT) introduced a method in which the interferometric signal is sampled by a detector as a function of wavelength rather than mirror position. This enables faster imaging with improved sensitivity. Typically, an object point in a sample is interrogated with a light source that sweeps through a range of optical frequencies (i.e., a swept source). As a result, the object point is illuminated with a monochromatic beam whose optical frequency is a function of time. This results in an interferometric signal of intensity versus wavenumber, k (k is proportional to the inverse of wavelength). A mathematical algorithm, referred to as a Fourier transform, is then used to convert the interferometric signal to a plot of intensity versus depth.

The advantages of swept-source implementations over time-domain OCT include improved signal-to-noise ratio and faster scan rates. The wavelength-sweep rate of a swept-source FD-OCT system can exceed 300 kHz using a research-grade Fourier-domain Mode-locking (FDML) laser. As a result, an FDML-based swept-source system is capable of generating a 100×100×512 pixel-volume dataset at 30 Hz (i.e., in real time). Unfortunately, such a small cross-sectional area has limited utility in many applications. Further, when using a commercially available swept source, which has a typical sweep rate of only about 100 kHz, an FD-OCT system can develop a 100×100×512 pixel-volume dataset at only 10 Hz, which is much slower than necessary for real-time imaging.

Spectral-domain OCT (SD-OCT) represented yet another advance in the OCT field and enabled imaging systems with improved imaging speed and sensitivity. In a typical SD-OCT system, an object point is interrogated with broad-spectrum light. Light reflected from the object point is dispersed by wavelength along a row of detectors, which simultaneously provide a different output signal for each of a plurality of wavelength components. As a result, information is collected from many depths within the object point at the same time, and a Fourier transform operation can be used to convert this information into a plot of intensity versus depth.

Unfortunately, the information from one object point must be integrated fully on the detectors before a second object point can be imaged. As a result, the time required for detector integration and readout represents a significant bottleneck for conventional SD-OCT systems. In addition, although no wavelength scanning is needed (in contrast to a swept-source system), the speed of the detectors used in spectral domain OCT systems are typically slower than the scan rate of the sources in swept-source systems. For example, typical commercial systems have equivalent line rates of 29 kHz, which corresponds to a maximum image rate of only 2.9 Hz for a 100×100×512 volume dataset. Recent improvements in commercially available linear detectors have improved the potential line rate to 140 kHz; however, this corresponds to a maximum image rate of only approximately 14 Hz—still woefully inadequate for real-time imaging applications.

To improve image acquisition times, single-point SD-OCT systems have been parallelized such that a full B-scan is produced at one time. In a typical implementation of a parallel SD-OCT, a cylindrical lens casts broadband light over a line of object points. The wavelength components in the reflected light from each object point are dispersed along a different row of detectors within a two-dimensional detector array (e.g., a CCD or CMOS camera array). In essence, such a system is analogous to linear array of single-point SD-OCT systems that collectively simultaneously sample a linear array of object points.

Although parallel SD-OCT systems enable significant improvement in imaging speed, they are not without drawbacks. First, the lateral resolution (i.e., the ability to distinguish adjacent object points on the sample) suffers from optical crosstalk. Optical crosstalk arises from the fact that all object points being imaged are illuminated by the same wavelengths. Since the light reflected by each object point is subject to some degree of scattering, each wavelength component in the light reflected by each object point is spread over several detectors of the detector array. In other words, a first detector that is intended to receive a first wavelength component from only a first object point also receives a portion of the same wavelength component reflected by the object points adjacent to the first object point (as well as other object points separated further from the first object point). This inadvertently received light represents noise that degrades the signal-to-noise ratio (SNR) of the output signal from each detector and, ultimately, degrades the sensitivity of the OCT system.

Second, although OCT is predicated on the assumption of measuring light that has been scattered only once (that is, ballistic photons) much of the light scattered by the object points is scattered more than once. As a result, when multiple object points are illuminated, there is a significant likelihood that at least some of the light received at one detector was scattered between multiple object points. This further degrades the sensitivity of the OCT system.

Third, parallel SD-OCT systems are typically free-space systems, although they have also been implemented using a fiber bundle. The use of a fiber bundle inherently limits the lateral resolution of such systems, however. Although the use of a single-mode fiber (as is typical in other OCT approaches) is highly desirable for portability and robustness of the system design, the use of a single fiber severs the spatial mapping between the reflected light signals and the object points from which they are reflected.

More recently, STREAK-mode OCT has been developed, in part, to overcome some of these limitations of parallel SD-OCT. In a STREAK-mode OCT system, a single-mode optical fiber output is scanned along a line of object points so that each object point is individually sampled. As in parallel SD-OCT, the wavelength components reflected by each object point are dispersed along a single row of a two-dimensional detector array. As the illumination is scanned along the row of object points, the dispersed reflected signal is scanned from row to row along the detector such that only the row of detectors associated with the object point being sampled at any given time is illuminated. As a result, the correlation between the object points and their respective output signals is maintained.

This approach enables faster imaging speeds because the entire detector array can be illuminated in less time than the period of a single camera frame, enabling the detector array to operate at its normal frame rate. Given the large number of rows in a commercially available high-speed camera, a row of object points can be scanned at a faster rate than is possible using a conventional one-dimensional spectrometer-based OCT system.

Unfortunately, the motion of the wavelength signals across the detector array leads to significant blurring of the spectrum in each row, which lead, in turn to a reduction in sensitivity. Further, STREAK-mode OCT systems are complicated by the need to synchronize the scanners at the detector and sample planes.

As a result, even with the advances in parallel SD-OCT, real-time imaging of three-dimensional volumes of reasonable size and resolution still eludes the OCT community.

### SUMMARY OF THE INVENTION

The present invention enables high-speed OCT image formation with good depth resolution and system sensitivity. Embodiments of the present invention are well suited for developing three-dimensional images in real time, in application areas such as ophthalmology, developmental biology, cancer screening, endoscopy, cardiology, cellular dynamics, and the like.

The present invention enables an interferometer-based OCT system that interrogates a line of M object points on a sample, wherein each object point is interrogated with a unique set of wavelength components. Each unique set of wavelength components spans approximately the same spectral range and the wavelength components of all of the sets of wavelength components are collectively spectrally interleaved. At the sample, each object point reflects a light signal that is based on its respective set of wavelength components and the surface and sub-surface features at that object point. The reflected light signals are combined with a reference signal in the reference arm of the interferometer such that the M reflected signals collectively define M interferometric signals that are themselves spectrally interleaved. The spectral components in the interferometric signal are then spatially dispersed onto a detector array such that each wavelength component is incident on a different detector of the array. As a result, the detector array provides a plurality of output signals that are inherently spatially and spectrally mapped to each object point in the row, thereby mitigating optical crosstalk issues that plague parallel OCT systems of the prior art. An OCT system in accordance with the present invention, therefore, enables rapid imaging of the surface and sub-surface features of all M object points with high SNR and sensitivity.

An illustrative embodiment of the present invention is a method wherein light containing a plurality of wavelength components that span a wavelength range is provided to an interferometer as a first optical signal. The interferometer distributes the first optical signal equally into a reference signal in a reference arm and a sample signal in a sample arm. In the sample arm, the wavelength components in the sample signal are spatially dispersed over a line of object points on a sample by a first disperser. The first disperser disperses the wavelength components such that each object point is simultaneously interrogated with a unique set of wavelength components, wherein the wavelength components incident on the plurality of object points are collectively spectrally interleaved. As a result, each set of wavelength components substantially spans the complete wavelength range. At each object point, a subset of the incident wavelength components is reflected based on the surface and sub-surface structure of that object point. The reflected wavelength components are recombined with the reference signal to form an interferometric signal having wavelength components based on the structure of all of the interrogated object points. The interferometric signal is then conveyed to a second disperser that disperses the wavelength components in two dimensions onto the pixels of a two-dimensional detector array. The pixels are spatially and spectrally mapped to the interrogated object points and their output signals are provided to a processor. The processor is operative for performing a Fourier transform of the information in the output signals, which enables a complete B-scan of the line of object points to be developed in a single snapshot.

In some embodiments, at least one of the first and second dispersers comprises an Echelle grating. In some embodiments, at least one of the first and second dispersers comprises a virtual image phase array (VIPA). In some embodiments, at least one of the first and second dispersers comprises an etalon. In some embodiments, the second disperser is a one-dimensional disperser that spatially disperses the wavelength components of the interferometric signal across a one-dimensional detector array.

In some embodiments, the first optical signal is provided by a swept source having a wavelength that is swept over a wavelength range at a first frequency. The sample arm includes a scanner that repeatedly scans the sample signal over a line of object points on a sample during the sweep period of the optical source. As a result, the wavelength components in the interferometric signal are time encoded.

In some embodiments, K rows of M image points are sequentially scanned to provide a B-scan for each row of image points. A processor processes the K B-scans to form a three-dimensional image of the sample.

An embodiment of the present invention is a method for forming an image of a sample, the method comprising: interrogating a first object point of a plurality of object points on the sample with a first wavelength component set that substantially spans a first wavelength range; interrogating a second object point of the plurality of object points with a second wavelength component set that substantially spans the first wavelength range, wherein the first wavelength component set and the second wavelength component set are spectrally interleaved; reflecting a first reflected signal from the first object point, the first reflected signal being based on the surface and sub-surface structure of the first object point and the first wavelength component set; reflecting a second reflected signal from the second object point, the second reflected signal being based on the surface and sub-surface structure of the second object point and the second wavelength component set; forming an interferometric signal based on the first reflected signal and the second reflected signal, the interferometric signal including a third wavelength component set that is based on the first wavelength component set and the second wavelength component set; dispersing the third wavelength component set onto a detector array comprising a plurality of detector pixels, wherein each of the third wavelength component set is incident on a different detector pixel, and wherein each detector pixel provides one of a plurality of output signals based on its respective received wavelength component; and providing a first image of a first region of the sample, the first region including the first object point and the second object point, wherein the first image is a based on the plurality of output signals.

### BRIEF DESCRIPTION OF THE DRAWINGS

FIG. 1 depicts a schematic diagram of an SD-OCT system in accordance with the prior art.

FIG. 1B depicts a schematic drawing of a region of sample 124.

FIG. 1C depicts a portion of a pattern of a dispersed interferometric signal at a detector in accordance with the prior art.

FIG. 2 depicts a schematic diagram of a portion of an OCT system in accordance with an illustrative embodiment of the present invention.

FIG. 3 depicts operations of a method for imaging a sample in accordance with the illustrative embodiment of the present invention.

FIG. 4A depicts a schematic drawing of a portion of a sample arm in accordance with the illustrative embodiment of the present invention.

FIG. 4B depicts a schematic drawing of column 138-i as interrogated with dispersed optical signal 240.

FIG. 5 depicts a schematic drawing of a detector array illuminated with a cross-dispersed interferometric signal in accordance with the illustrative embodiment of the present invention.

FIG. 6 depicts a schematic diagram of a portion of an OCT system in accordance with an alternative embodiment of the present invention.

FIG. 7 depicts operations of a method for imaging a sample in accordance with the alternative embodiment of the present invention.

FIG. 8 depicts a plot of the wavelength of optical signal 606 versus time.

FIG. 9 depicts a plot of scanner position during a single sweep period, T₁.

FIG. 10 depicts a plot of an illumination pattern on a detector in accordance with the illustrative embodiment of the present invention.

### DETAILED DESCRIPTION

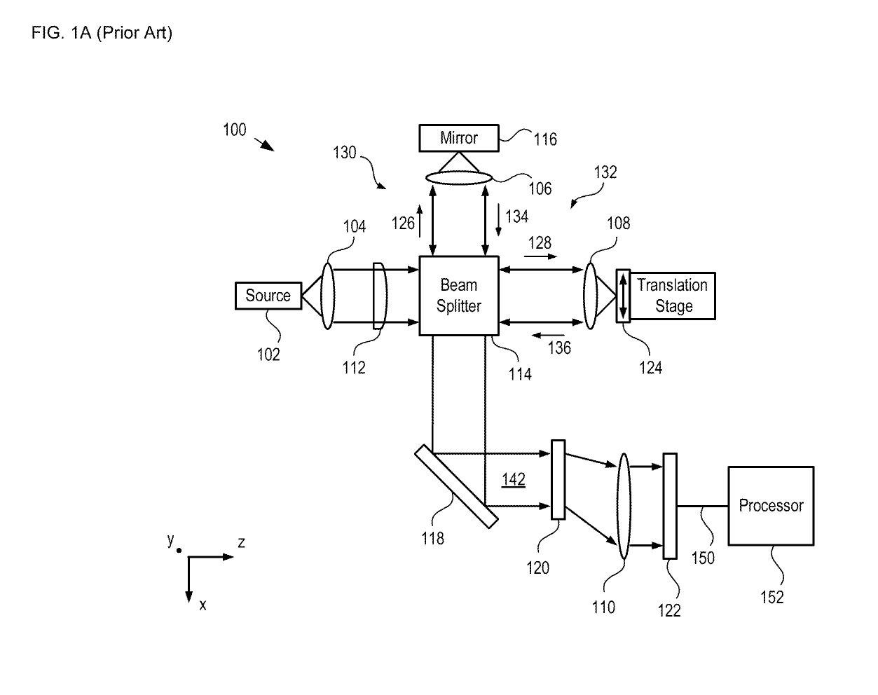

FIG. 1 depicts a schematic diagram of a line-field SD-OCT system in accordance with the prior art. System 100 comprises source 102, lenses 104, 106, 108, and 110, cylindrical lens 112, beam splitter 114, mirrors 116 and 118, grating 120, detector 122, and processor 152.

Source 102 is a broadband light source, such as a super luminescent diode, LED array, and the like, which has a wavelength range (i.e., spectral bandwidth) of tens of nanometers and includes N wavelength components, λ1-λN. Light provided by source 102 is collimated at lens 104 and focused into a line-shaped optical beam at cylindrical lens 112.

Beam splitter 114 splits the light equally into signals 126 and 128 in reference arm 130 and sample arm 132, respectively.

Lens 106 focuses signal 126 onto mirror 116, which reflects the light back through lens 106 as signal 134, which propagates to beam splitter 114. Typically, the position of mirror 116 is fixed; therefore, the total length of reference arm 130 remains constant.

Lens 108 focuses signal 128 onto sample 124 to illuminate a line of M object points, which are, for example, oriented along the y-direction (as indicated).

FIG. 1B depicts a schematic drawing of a region of sample 124. Sample 124 is segmented into columns 138-i, where 1≦i≦k of object points 140-i,j, where 1≦j≦M (referred to, collectively, as object points 140). The size of each object point is determined by the optical resolution of system 100.

In the example depicted in FIG. 1B, column 138-1 is illuminated with signal 128. Based on its surface and sub-surface features, each of illuminated object points (i.e., object points 140-1,1 through 140-1,M) reflects light back through lens 108 as signal 136, which propagates to beam splitter 114. During a full three-dimensional scan of sample 124, columns 138-1 through 138-K are sequentially illuminated and scanned. In some cases, M is less than the number of object points in each column 138 and vertical indexing is required in order to scan sample 124 completely.

At beam splitter 114, signals 134 and 136 are combined to form interferometric signal 142, which is reflected by mirror 118 toward grating 120.

At grating 120, the wavelength components in interferometric signal 142 are spatially dispersed along a direction that is orthogonal to the orientation of the linear light signal. As described here, the wavelength components are dispersed along the x-direction, for example. The spatially dispersed wavelength components are then provided to detector 122 for detection.

FIG. 1C depicts a portion of a pattern of a dispersed interferometric signal at a detector in accordance with the prior art. Detector 122 is shown with dispersed interferometric signal 142 incident upon its surface.

Detector 122 comprises a two-dimensional array of identical pixels—namely, pixels 144-j,k, where 1≦k≦N, (referred to, collectively, as pixels 144). Typically, detector 122 is a CCD array or equivalent. Pixels 144 are segmented into rows 146-1 through 146-M (referred to, collectively, as rows 146) and columns 148-1 through 148-N (referred to, collectively, as columns 148). Note that in this example, there is a one-to-one correspondence between the pixels in each column of detector 122 and the number of object points in each column 138-i of sample 124. Each row 146-j simultaneously receives wavelength components from its corresponding object point 140-j of the column 138-i being sampled. In this example, column 138-1 of sample 124 is being interrogated with signal 128. As a result: pixels 144-1,1 through 144-N,1 in row 146-1 receive the wavelength components reflected by object point 140-1,1 of sample 124; pixels 144-1,2 through 144-N,2 in row 146-2 receive the wavelength components reflected by object point 140-1,2 of sample 124; pixels 144-1,3 through 144-N,3 in row 146-3 receive the wavelength components reflected by object point 140-1,3 of sample 124; and so on.

Detector 122 provides output signals 150 to processor 152, which is operative for performing a Fourier transform of the information in output signals 150 to provide a complete B-scan of column 138-i in a single snapshot.

Sample 124 is then repeatedly indexed, typically via a translation stage, to enable system 100 to perform a complete B-scan of the remaining columns 138-i of sample 124. In some cases, relative motion between signal 128 and sample 124 is imparted by scanning signal 128 over the sample via a scanner, such as a galvanometer mirror or MEMS mirror.

Unfortunately, the resolution of system 100 is limited by the fact that, while the wavelengths are dispersed along the pixels in each row 146, they are dispersed identically for each row. In other words, each pixel within each of columns 148 receives light having the same wavelength. For example, every pixel in column 148-1 receives wavelength component λ1, every pixel in column 148-2 receives wavelength component λ2, every pixel in column 148-5 receives wavelength component λ5, and so on. As a result, within each column, every pixel in a column is providing an output signal based on the same wavelength component, making them subject to optical crosstalk. Optical crosstalk arises from several sources. First, each object point 140 scatters the light it reflects to some extent. As a result, each wavelength component in the light reflected by each object point 140 is incident on its corresponding pixel 144, as well as several neighboring pixels. For example, wavelength component λ2 reflected by object point 140-1,2 is principally incident on pixel 144-2,2. However, some of the reflected wavelength component is also incident on pixels 144-2,1, 144-2,3, and to a lesser extent, 144-2,4, and so on. The light received by each of these adjacent pixels represents noise in their respective output signals, which degrades the SNR and sensitivity of the system 100.

Second, light scattered by one object point being illuminated can be scattered again by other object points in sample 124. As a result, a wavelength component received by one detector could have included light scattered between multiple object points. This further degrades the sensitivity of the OCT system.

Third, OCT systems such as system 100 are inherently free-space systems. As a result, they typically tend to be large and bulky. In addition, attaining and maintaining proper alignment of their optical components can be prohibitively expensive.

In contrast, the present invention enables unique spectral mapping between the output signals based on the wavelength components reflected by object points 140 and the object points themselves. Further, the present invention enables a complete B-scan of a line of object points to be developed in a single snapshot without significant loss of depth resolution or significantly diminished signal-to-noise ratio.

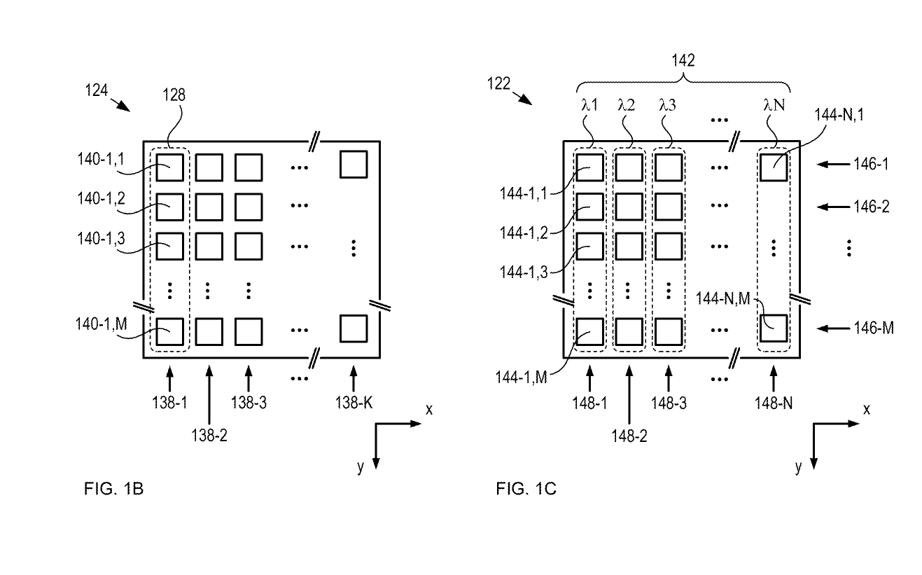

FIG. 2 depicts a schematic diagram of a portion of an OCT system in accordance with an illustrative embodiment of the present invention. System 200 is an OCT system capable of producing three-dimensional images of a sample in real time. System 200 is analogous to a Michelson interferometer having a sample arm that comprises a disperser that disperses a sample signal comprising a plurality of wavelength components over a line of object points on the sample such that each object point is interrogated with a unique set of wavelength components, each which spans substantially the same wavelength range as the sample signal. Wavelength components reflected by the object points are detected at a two-dimensional array of detector pixels, which are spatially and spectrally mapped to the object pixels. As a result, system 200 can develop a complete B-scan of the line of object points in a single snapshot. Although the illustrative embodiment comprises a Michelson interferometer arrangement, it will be clear to one skilled in the art, after reading this Specification, how to specify, make, and use alternative embodiments that comprise other interferometer arrangements.

System 200 comprises source 202, optical fibers 204, 206, 208, and 210, beam splitter 212, lenses 214 and 216, mirror 218, disperser 220, disperser 222, detector array 224, and processor 152.

Although the illustrative embodiment comprises an interferometer that is optical fiber based (i.e., the elements of the interferometer are fiber coupled with one another), it will be clear to one skilled in the art, after reading this Specification, how to specify, make, and use alternative embodiments of the present invention wherein at least a portion of system 200 comprises a free-space optical arrangement. In other words, in some embodiments of the present invention, at least one optical element (e.g., source 202, beam splitter 212, mirror 218, dispersers 220 and 222, detector array 224, etc.) is optically coupled with system 200 via free space.

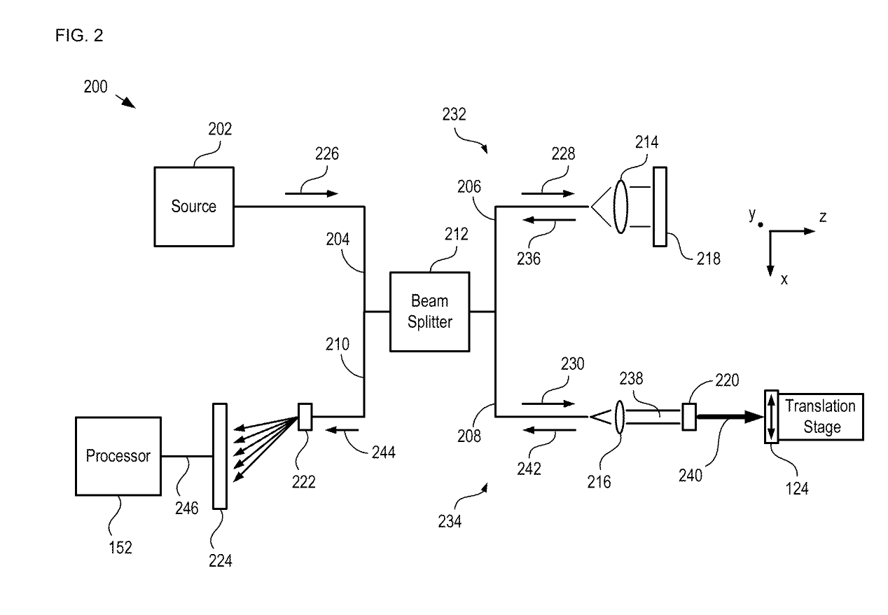

FIG. 3 depicts operations of a method for imaging a sample in accordance with the illustrative embodiment of the present invention. Method 300 begins with operation 301, wherein source 202 provides broadband optical signal 226 (hereinafter referred to as “optical signal 226”) to beam splitter 212 via optical fiber 204.

Source 202 is a super-luminescent diode-based light source having a wavelength range, R₁, that extends from approximately 760 nanometers (nm) to approximately 880 nm. The wavelength range of source 202 includes N wavelength components, λ1-λN. Source 202 is analogous to source 102 described above. Light provided by source 202 is coupled into optical fiber 204 in conventional fashion. Although the illustrative embodiment comprises a light source having a wavelength within the range of 760 nm to 880 nm, it will be clear to one of skill in the art, after reading this Specification, how to specify, make, and use alternative embodiments of the present invention that comprise a light source that provides light at other wavelengths and/or that have any suitable wavelength range. It will also be clear, after reading this Specification, how to specify, make, and use alternative embodiments that comprises a light source other than a super-luminescent diode. Sources suitable for use with the present invention include, without limitation, super-luminescent diodes, mode-locked lasers, super-continuum lasers, and the like.

At operation 302, beam splitter 212 distributes optical signal 226 equally into optical signals 228 and 230 into reference arm 232 and sample arm 234, respectively. Beam splitter 212 is a conventional optical splitter/combiner having a split ratio of 50:50. In some embodiments, the split ratio of beam splitter 212 is other than 50:50 (e.g., 80:20, 90:10, etc.).

Reference arm 232 comprises optical fiber 206, conventional lens 214, and mirror 218. In reference arm 232, lens 214 receives free-space optical signal 228 from optical fiber 206, collimates it, and directs it to mirror 218. Mirror 218 reflects optical signal 228, which is then coupled back into optical fiber 206 by lens 214 as optical signal 236.

At operation 303, optical signal 230 is provided to disperser 220 as free-space optical signal 238.

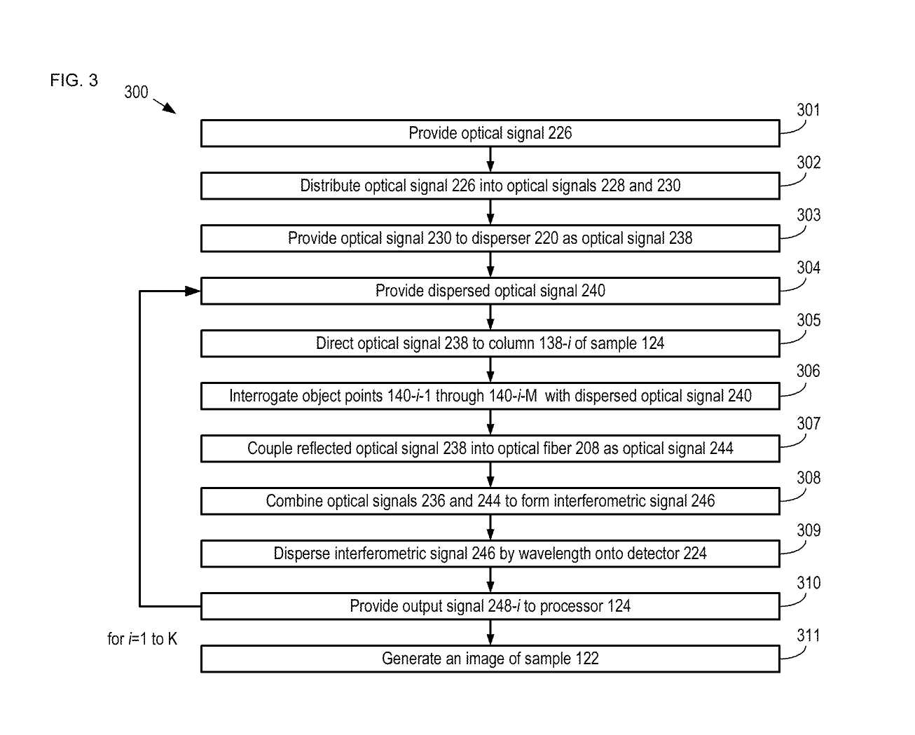

FIG. 4A depicts a schematic drawing of a portion of a sample arm in accordance with the illustrative embodiment of the present invention. Sample arm 234 comprises optical fiber 208, disperser 220, optical fiber 208 and conventional lens 216. Conventional lens 216 receives optical signal 230 as a free-space signal launched from optical fiber 208, collimates it, and directs it to disperser 220 as free-space optical signal 238 (hereinafter referred to as “optical signal 238”).

At operation 304, disperser 220 provides dispersed optical signal 240.

Disperser 220 is an Echelle grating having a free spectral range (FSR) that is X-times smaller than R₁. Disperser 220 receives optical signal 238 and apportions R₁ into wavelength bands 402-1 through 402-X (each corresponding to a different diffraction order of the grating). Each of wavelength bands 402-1 through 402-X has a wavelength range, R₂ that is substantially equal to R₁/X. The X wavelength bands are spatially dispersed such that they physically overlap in the same region.

Although the illustrative embodiment disperser 220 comprises an Echelle grating, it will be clear to one skilled in the art, after reading this Specification, how to specify, make, and use alternative embodiments of the present invention wherein disperser 220 comprises a different wavelength dispersion element. Wavelength dispersion elements suitable for use in embodiments of the present invention include, without limitation, Echelle gratings, etalons, VIPAs, diffraction gratings, and the like.

At operation 305, dispersed optical signal 240 is directed to column 138-i, which leads to a different portion of dispersed optical signal 240 being incident on each of object points 140-i-1 through 140-i-M.

At operation 306, object points 140-i-1 through 140-i-M are interrogated with dispersed optical signal 240.

FIG. 4B depicts a schematic drawing of column 138-i as interrogated with dispersed optical signal 240.

As a result, each object point receives a different subset of wavelength components λ1 to λN (i.e., wavelength component subsets 404-1 through 404-M), wherein each wavelength component subset 404 includes X wavelength components that substantially span R₁, and wherein the wavelength component subsets are spectrally interleaved. One skilled in the art will recognize that the number of wavelength bands 402 provided by disperser 220 preferably numbers in the tens to hundreds so that each object point is interrogated with a rich set of wavelength components. It should be noted that the wavelength range of the light that illuminates each object point differs from R₁ by a small amount (based on the values of M and X); however, this difference is typically negligible. For the purposes of this Specification, including the appended claims, therefore, the wavelength range of the wavelength component subsets that illuminate each object point is defined as being equal to R₁. It should also be noted that in some embodiments, the FSR of disperser 220 is a non-integer factor of the wavelength range of optical signal 238; therefore, the wavelength component subsets do not include an equal number of wavelength components.

Dispersed optical signal 240, therefore, includes wavelength component subsets 404-1 through 404-M (referred to, collectively, as subsets 404). Subset 404-1 includes every Mth wavelength component beginning with λ1 (i.e., λ1, λ(M+1), λ(2M+1) . . . , and λ(N−M)), which are incident on object point 140-i-1. Subset 404-2 includes every Mth wavelength component beginning with λ2 (i.e., λ2, λ(M+2), λ(2M+2) . . . , and λ(N−M+1)), which are incident on object point 140-i-2, and so on, through subset 404-M, which includes every Mth wavelength component beginning with (i.e., λM, λ(2M), λ(3M) . . . , and λ(N)), which are incident on object point 140-i-M. In other words, the wavelength components included in subsets 404 are collectively spectrally interleaved, and each of object points 140 is interrogated with a set of wavelength components that span substantially the same wavelength range (which is also substantially equal to the wavelength range of optical signal 238).

One skilled in the art will recognize that depth resolution is based on the wavelength range of the light used to interrogate an image point. It is an aspect of the present invention, therefore, that an M-fold increase in image acquisition rate is enabled without suffering a significant loss of depth resolution.

At operation 307, the wavelength components reflected by object points 140-1 through 140-5 (based on their respective surface and sub-surface features) are coupled back into optical fiber 208 as optical signal 242.

At operation 308, optical signals 236 and 242 are combined at beam splitter 212 to form interferometric signal 244.

At operation 309, disperser 222 disperses interferometric signal 244, by wavelength, onto detector array 224.

Disperser 222 is a cross-disperser that spatially disperses the wavelength components in interferometric signal 244 in two-dimensions onto the surface of detector array 224. Disperser 222 includes an Echelle grating that is optically coupled with a prism whose direction of diffraction is oriented perpendicular to that of the Echelle grating.

In some embodiments, disperser 222 comprises a wavelength dispersion element other than an Echelle grating, such as a diffraction grating, etalon, VIPA, prism, and the like. Examples of dispersion elements suitable for use with the present invention are described in U.S. patent application Ser. No. 13/160,879.

Detector array 224 is a conventional charge-coupled device (CCD) array having detector pixels suitable for detecting the wavelength components in interferometric signal 244.

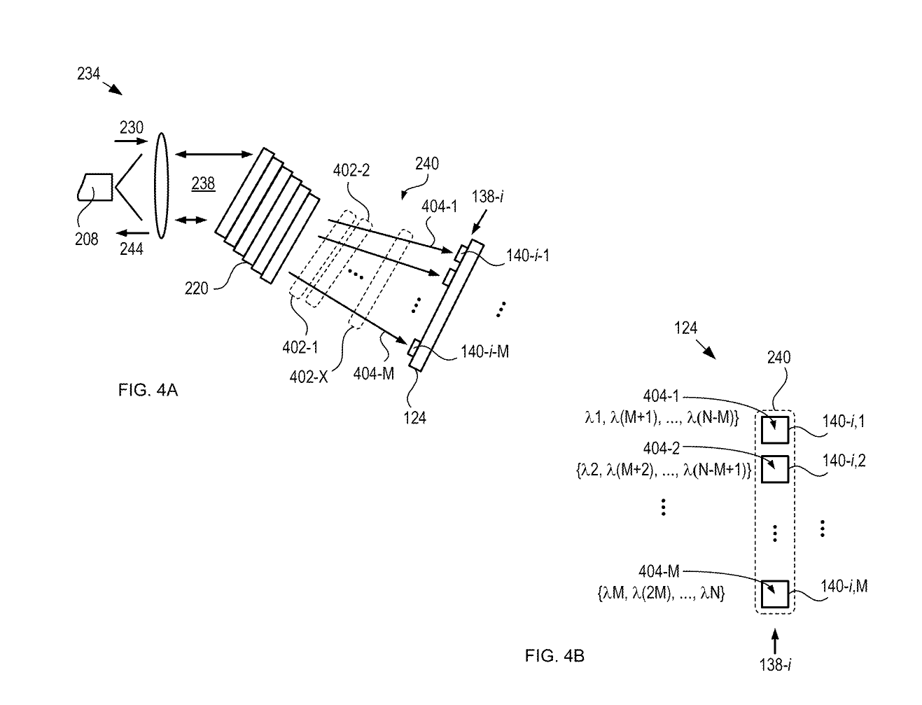

FIG. 5 depicts a schematic drawing of a detector array illuminated with a cross-dispersed interferometric signal in accordance with the illustrative embodiment of the present invention. Detector array 224 comprises detector pixels 502-1,1 through 502-N,M, which are arranged in columns 504-1 through 504-N and rows 506-1 through 506-M.

During the interrogation of the object points in column 138-i of sample 124, object points 140-i-1 through 140-i-M are spatially mapped by disperser 222 to rows 506-1 through 506-M, respectively. As a result, disperser 222 distributes, by wavelength, the reflected wavelength components from object point 140-i-1 across the detector pixels of row 506-1, the reflected wavelength components from object point 140-i-2 across the detector pixels of row 506-2, the reflected wavelength components from object point 140-i-3 across the detector pixels of row 506-3, and so on. The wavelength components from each object point are, therefore, both spatially and spectrally mapped to the detector pixels of detector array 224. Since disperser 220 directs X wavelength components to each of object points 140-i-1 through 140-i-M, only a maximum of X detector pixels in any one of rows 506 receive a wavelength component (as shown in FIG. 5).

One skilled in the art will recognize, after reading this Specification, that a CCD array is merely one example of a two-dimensional detector array suitable for use with the present invention, and that detector array 224 can comprise a two-dimensional array of any detector pixels that are operative for detecting the wavelength components in interferometric signal 244. Further, in some embodiments, grating 222 is a one-dimensional wavelength dispersion element. In such embodiments, detector array 224 is a linear array of detector pixels having a number of elements sufficient to detect all the pertinent wavelength components in interferometric signal 244. It should be noted that, although it is unnecessary for embodiments of the present invention to use a two-dimensional detector array, the high pixel density of readily available detector arrays, such as CCD camera elements, afford advantages to some embodiments of the present invention.

Due to their dispersion by disperser 222, the wavelength components associated with each given object point are automatically detected by the correct detector pixels. Because each object point is illuminated by a unique set of wavelength components, each wavelength is associated with a unique object point and there is substantially no optical crosstalk between the detector pixels of detector 244. As a result, embodiments of the present invention are capable of imaging an entire line of object points at the same time with higher SNR operation and, therefore, improved sensitivity over OCT systems of the prior art.

At operation 310, detector 244 provides output signal 248-i to processor 152. Output signal 248-i includes the output signals from each of detector pixels 250-1 through 250-N, from which processor 152 develops a full B-scan of column 138-i.

At operation 311, processor 152 develops an image of sample 122 based on output signals 248-1 through 248-K.

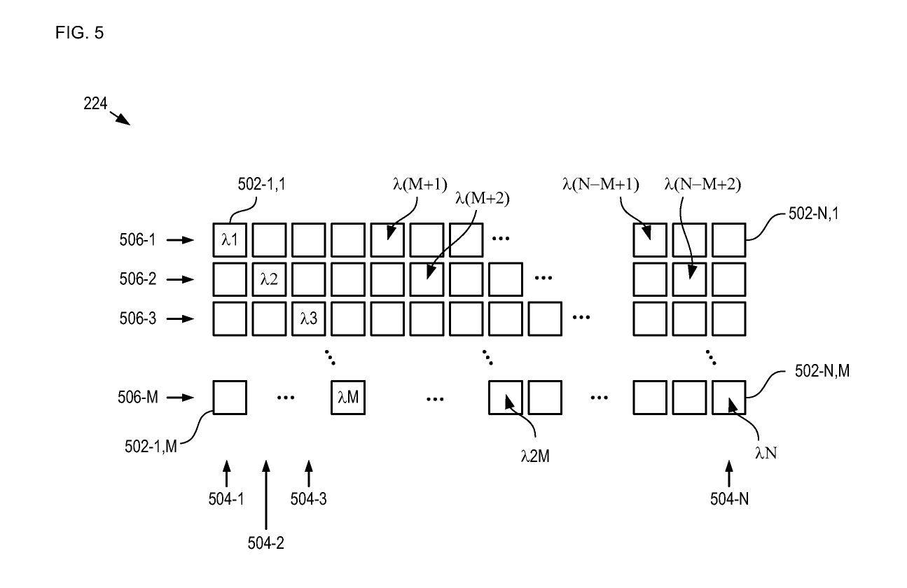

FIG. 6 depicts a schematic diagram of a portion of an OCT system in accordance with an alternative embodiment of the present invention. System 600 comprises source 602, optical fibers 204, 206, 208, and 210, beam splitter 212, lenses 214 and 216, mirror 218, disperser 604, disperser 222, detector array 224, and processor 152. System 600 is analogous to system 200, described above and with respect to FIG. 2; however, system 600 interrogates each of object points 140-i-1 through 140-i-M with a unique wavelength component subset by scanning a swept source signal X times over the object points during each wavelength sweep period of a the swept source.

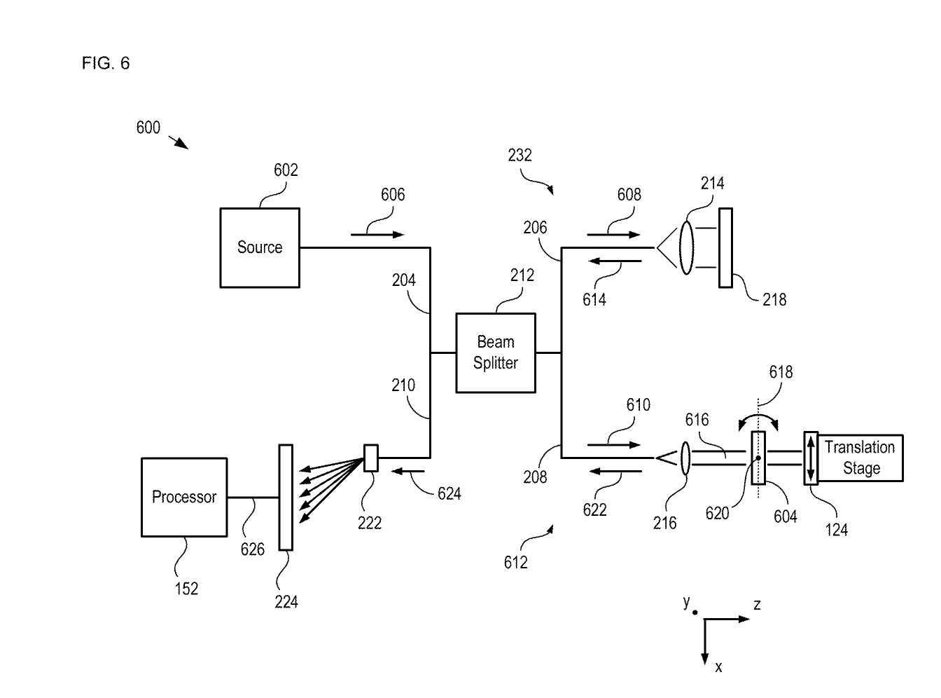

FIG. 7 depicts operations of a method for imaging a sample in accordance with the alternative embodiment of the present invention. Method 700 begins with operation 701, wherein source 602 provides swept-wavelength optical signal 606 (hereinafter referred to as “optical signal 606”) to beam splitter 212 via optical fiber 204.

Source 602 is a broadband light source optically coupled with an external tunable wavelength filter. Source 602 provides narrow spectral line-width light whose wavelength is continuously swept over wavelength range, R₁ (i.e., from approximately 760 nanometers (nm) to approximately 880 nm). Source 602 provides optical signal 606 as a periodic signal having a period, T₁, which is equal to the time required to sweep the wavelength of source 602 from 760 nm to 880 nm. It will be clear to one skilled in the art, after reading this Specification, how to specify, make, and use source 602.

Sources suitable for use with the present invention include narrow line-width, tunable sources such as, without limitation, external cavity tunable lasers, super-luminescent diodes, super-continuum generation light sources, akinetic swept sources, tunable vertical cavity light emitting diodes (VCSELs), tunable fiber lasers, broad-band sources coupled with tunable wavelength filters, and the like. Further, one skilled in the art will recognize that embodiments of the present invention are suitable for operation in different wavelength regimes. Further, the depth resolution of OCT depends on the temporal coherence characteristics of the light source used. The emergence of a new generation of super-broadband sources, therefore, has facilitated construction of OCT systems with micron-scale resolution. One such super broadband source is the Fourier-domain mode-locking laser (FDML). In some embodiments of the present invention, source 602 comprises an FDML-based laser. FDML-based lasers are well suited for use as source 602 due to their potential for high-speed wavelength tuning over a relatively wide spectral range, while maintaining high power output. For example, FDMLs have been demonstrated that are capable of sweeping their wavelength over a spectral width of nearly 150 nm at frequencies of over 300 kHz. Further, FDMLs have been developed for operation in many different wavelength regimes, including 1000 nm, 1300 nm, and 1500 nm.

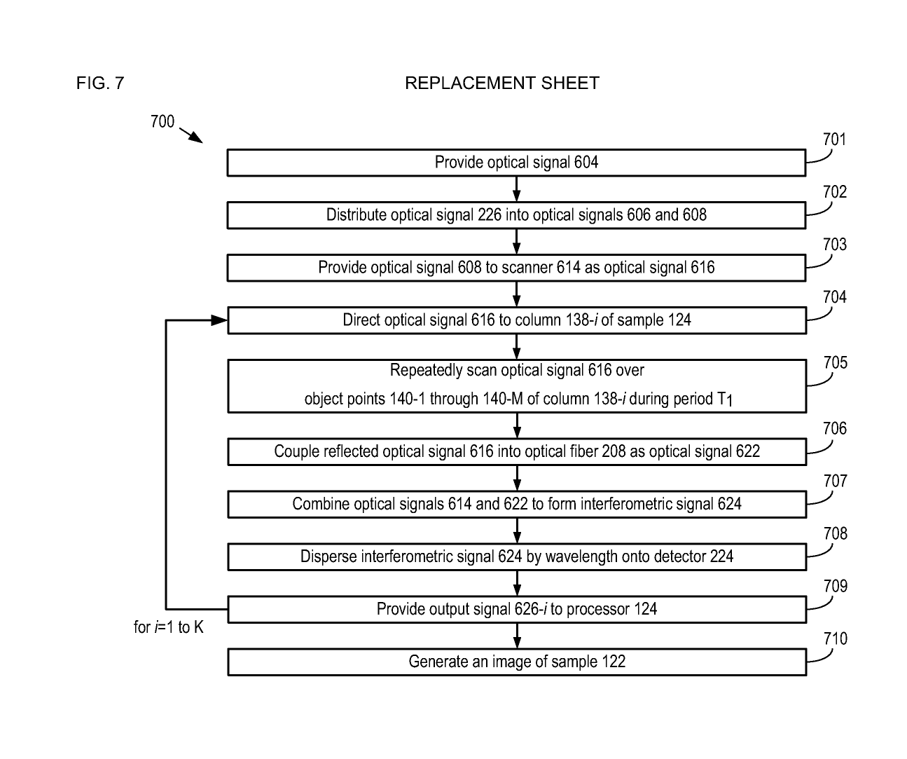

FIG. 8 depicts a plot of the wavelength of optical signal 606 versus time. Plot 800 depicts optical signal 606 for a source 602 that operates at a line rate (i.e., sweep frequency) of approximately 333 kHz; therefore, T₁ is approximately equal to 3.0 microseconds.

At operation 702, beam splitter 212 distributes optical signal 606 equally into optical signals 608 and 610 into reference arm 232 and sample arm 612, respectively.

At operation 703, optical signal 610 is provided to disperser 604 as free-space optical signal 616.

At operation 704, optical signal 610 is directed to column 138-i of sample 124.

Disperser 604 comprises a dual-axis, MEMS-based scanning mirror that is rotatable about each of axes 618 and 620. One skilled in the art will recognize that disperser 604 includes merely one type of scanner suitable for use with the present invention and myriad alternative scanners are within the scope of the present invention, such as examples of scanners described in the parent application to this patent application—U.S. patent application Ser. No. 13/160,879.

At operation 705, disperser 604 scans free-space optical signal 616 X times along each of the M object points in the column during period, T₁. The scan frequency of disperser 604 is higher than the sweep frequency of source 602 and typically an integer multiple of the sweep frequency. As a result, each of object points 140-i,1 through 140-i,M in column 138-i is interrogated with a set of X unique wavelength components within wavelength range R₁.

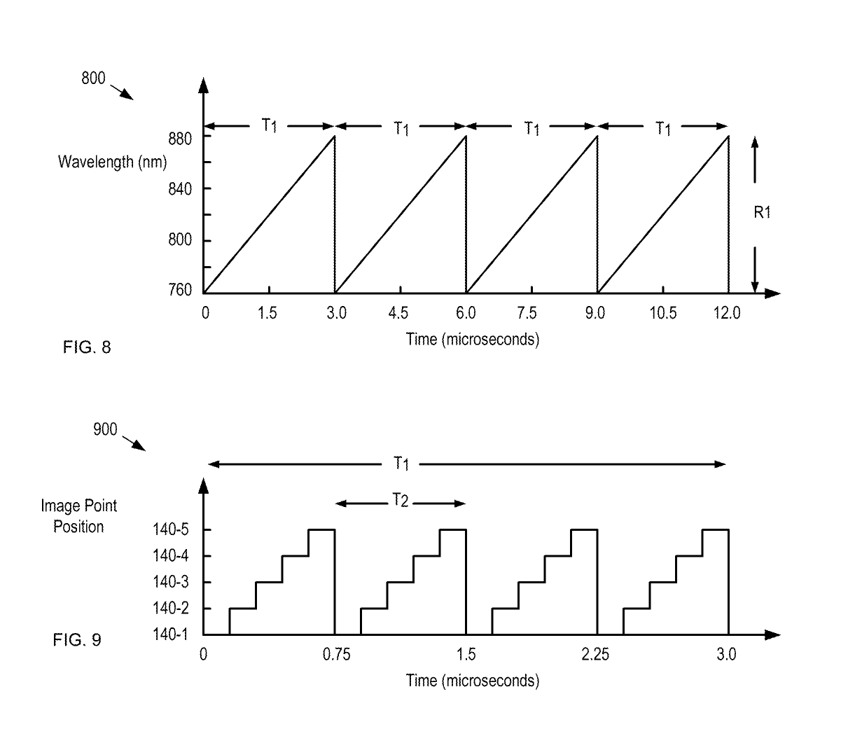

FIG. 9 depicts a plot of scanner position during a single sweep period, T₁. To simplify the description of the present invention, for the example depicted in FIG. 9, sample 124 is delineated into columns of five object points (i.e., M=5) and the scan rate of disperser 604 is four times the sweep rate of source 602 (i.e., X=4). One skilled in the art will recognize that in a typical sample, the number of object points in each column, as well as the number of columns, would be in the hundreds or thousands. Further, the scan rate of disperser 604 is typically much greater than four times the sweep rate of source 602 to ensure that each object point is interrogated with a sufficient number of wavelength components.

As seen from plot 900, during a single sweep period T₁, disperser 604 sequentially directs optical signal 616 to each of object points 140-1 through 140-5 during each of the four scanning periods, T₂, of each sweep period, T₁. As a result, during a single sweep of the wavelength of optical signal 606 through wavelength range R₁, optical signal 616 is incident on each object point in column 138-i four times, each time while optical signal 616 is characterized by a different wavelength. As a result, during a single sweep period T₁, each object point is interrogated with multiple wavelength components and no wavelength component is incident on more than one object point.

Further, each of the object points in each column 138-i is illuminated with a wavelength component subset that substantially spans the entire wavelength range, R₁. In other words, each of object points 140-i,1 through 140-i,5 is interrogated by light spanning a wavelength range that is substantially equal to the wavelength range of optical signal 606.

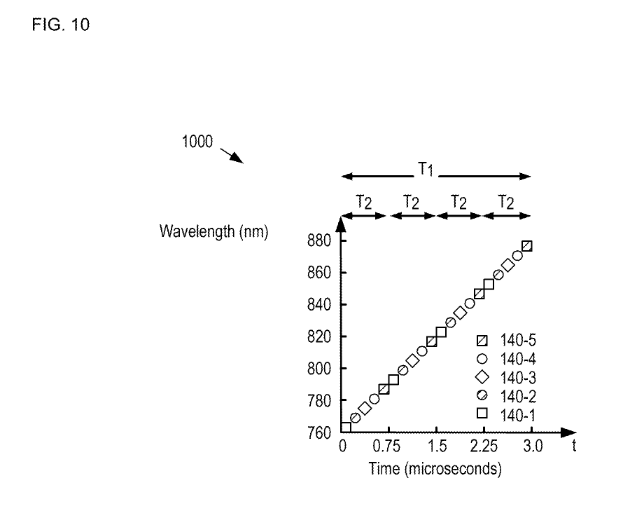

FIG. 10 depicts a plot of an illumination pattern on a detector in accordance with the illustrative embodiment of the present invention. Plot 1000 shows the relationship between wavelength and object point position as a function of time. Object point position is denoted by symbol, as shown in the legend included in FIG. 10. As discussed above, during each scanning period, T₂, optical signal 616 is sequentially indexed from object point 140-1,1, to object point 140-i,2, to object point 140-i,3, to object point 140-i,4, and to object point 140-i,5 within column 138-i. In some embodiments, the residence time for optical signal 238 at each object point in a column is based on the sampling bandwidth of detector 224. In some embodiments, optical signal 616 is swept across the object points in a column at a continuous scan rate, rather than in discrete steps between each object point.

Since the wavelength of optical signal 616 is changing at a constant rate during each scanning period, each of object points 140-i,1 through 140-i,5 receives a different wavelength component during each scanning period. For example, during the scanning period from t=0 to t=1.5, object point 140-i,1 is illuminated by a wavelength component centered at approximately 763 nm, object point 140-i,2 is illuminated by a wavelength component centered at approximately 769 nm, object point 140-i,3 is illuminated by a wavelength component centered at approximately 775 nm, object point 140-i,4 is illuminated by a wavelength component centered at approximately 781 nm, and object point 140-i,5 is illuminated by a wavelength component centered at approximately 787 nm.

This pattern of illumination continues for each of the remaining scanning periods in sweep period T₁. As a result, each object point is interrogated by four different wavelength components over a spectral width that is substantially equal to the spectral width (i.e., R₁) of free-space optical signal 616. For example, over the entire sweep period from t=0 to t=3.0, object point 140-2 is illuminated by wavelength components centered at approximately 769, 799, 829, and 859 nm. In similar fashion, object point 140-4 is illuminated by wavelength components centered at approximately 781, 811, 841, and 871 nm. In other words, object points 140-1 through 140-5 are illuminated by wavelength components that are spectrally interleaved.

At operation 709, detector 224 provides output signal 626-i to processor 152. Output signal 626-i includes the output signals from each of detector pixels 250-1 through 250-N, from which processor 152 develops a full B-scan of column 138-i.

At operation 710, processor 152 develops an image of sample 122 based on output signals 626-1 through 626-K.

It is to be understood that the disclosure teaches just one example of the illustrative embodiment and that many variations of the invention can easily be devised by those skilled in the art after reading this disclosure and that the scope of the present invention is to be determined by the following claims.

1. A method for forming an image of a sample, the method comprising:
interrogating a first object point of a plurality of object points on the sample with a first wavelength component set that substantially spans a first wavelength range;
interrogating a second object point of the plurality of object points with a second wavelength component set that substantially spans the first wavelength range, wherein the first wavelength component set and the second wavelength component set are spectrally interleaved;
reflecting a first reflected signal from the first object point, the first reflected signal being based on the surface and sub-surface structure of the first object point and the first wavelength component set;
reflecting a second reflected signal from the second object point, the second reflected signal being based on the surface and sub-surface structure of the second object point and the second wavelength component set;
forming an interferometric signal based on the first reflected signal and the second reflected signal, the interferometric signal including a third wavelength component set that is based on the first wavelength component set and the second wavelength component set;
dispersing the third wavelength component set onto a detector array comprising a plurality of detector pixels, wherein each of the third wavelength component set is incident on a different detector pixel, and wherein each detector pixel provides one of a plurality of output signals based on its respective received wavelength component; and
providing a first image of a first region of the sample, the first region including the first object point and the second object point, wherein the first image is a based on the plurality of output signals.

2. The method of claim 1 wherein the first object point and the second object point are interrogated simultaneously.

3. The method of claim 1 further comprising providing the plurality of detectors such that they are arranged in a two-dimensional arrangement.

4. The method of claim 1 further comprising providing the plurality of detectors such that they are substantially co-linear.

5. The method of claim 1 wherein the first wavelength component set and the second wavelength component set are provided by operations comprising:
providing an input optical signal, wherein the input optical signal includes a first wavelength range;
apportioning the first wavelength range into a plurality of wavelength bands; and
dispersing each of the plurality of wavelength bands over a first region of the sample such that the plurality of dispersed wavelength bands are substantially co-incident in the first region, wherein the first region includes the first object point and the second object point.

6. The method of claim 1 wherein the first set of wavelength components and the second set of wavelength components are provided by operations comprising:
providing an input optical signal that is periodic with a first period, T₁, wherein the input optical signal comprises input light having an wavelength that sweeps from a first wavelength to a second wavelength over a first wavelength range during each first period; and
scanning the input optical signal over the plurality of object points during each of a plurality of second periods, T₂, wherein the first period includes the plurality of second periods.

7. The method of claim 1 further comprising:
interrogating a third object point of the plurality of object points with a fourth wavelength component set that substantially spans the first wavelength range, wherein the first wavelength component set, the second wavelength component set, and the fourth wavelength component set are collectively spectrally interleaved; and
reflecting a third reflected signal from the third object point, the third reflected signal being based on the surface and sub-surface structure of the third object point and the fourth wavelength component set;
wherein the interferometric signal is formed based further on the third reflected signal, and wherein the first region further includes the third object point.

8. A method for forming an image of a sample, the method comprising:
(1) forming a plurality of B-scans, each of the plurality of B-scans being formed by scanning a different one of a plurality of columns of object points, wherein each of the plurality of columns is scanned by operations comprising:
(a) interrogating each object point in the column with a different one of a plurality of wavelength component sets, wherein no wavelength component is included in more than one of the plurality of wavelength component sets, and wherein the plurality of wavelength component sets is collectively spectrally interleaved, and further wherein each of the plurality of wavelength component sets is characterized by a first wavelength range;
(b) forming an interferometric signal based on the wavelength components reflected from each of the object points; and
(c) dispersing the wavelength components included in the interferometric signal onto a detector array comprising a plurality of detector pixels, wherein each of the plurality of detector pixels is uniquely spatially and spectrally mapped to one of the plurality of object points; and
(2) forming the image based on the plurality of B-scans.

9. The method of claim 8 wherein the plurality of wavelength component sets is provided by operations comprising:
apportioning an input optical signal characterized by the first wavelength range into a plurality of wavelength bands; and
dispersing each of the plurality of wavelength bands over the plurality of object points such that the plurality of wavelength bands are substantially co-incident, wherein each of the plurality of object points receives a different portion of each of the plurality of wavelength bands.

10. The method of claim 8 wherein the plurality of sets of wavelength components are provided by operations comprising:
providing an input optical signal that is periodic with a first period, T₁, wherein the input optical signal comprises input light having a wavelength that sweeps from a first wavelength to a second wavelength over a first wavelength range during each first period;
scanning the input optical signal over the plurality of object points during each of a plurality of second periods, T₂, wherein the first period includes the plurality of second periods.

11. The method of claim 8 wherein the interferometric signal is formed by operations comprising:
receiving a different one of the plurality of wavelength component sets at each of the plurality of object points;
at each object point, reflecting at least some of the received wavelength component set as a different one of a plurality of reflected signals, wherein the reflected signal is based on the surface and subsurface structure at the object point; and
combining the plurality of reflected signals.

12. The method of claim 8 further comprising providing the detector array such that the plurality of detector pixels is arranged in a two-dimensional array.

13. The method of claim 8 wherein the wavelength components of the interferometric signal are spatially dispersed onto the detector array by a disperser comprising an element selected from the group consisting of an Echelle grating and a virtual image phase array.

14. An optical coherence tomography system comprising:
a light source that is operative for providing a first optical signal having a first wavelength range comprising a first wavelength component set;
a first disperser, the first disperser being operative for dispersing the first wavelength component set over a plurality of object points on a sample such that each of the plurality of object points receives a different one of a plurality of second wavelength component sets, wherein the second wavelength component sets are collectively spectrally interleaved, and wherein the first wavelength component set comprises the plurality of second wavelength component sets;
a second disperser for spatially dispersing a third wavelength component set included in an interferometric signal, the third wavelength component set including wavelength components reflected by each of the plurality of object points; and
a detector comprising a plurality of detector pixels, each detector pixel being dimensioned and arranged to provide a different one of a plurality of output signals, each of the plurality of output signals being based on a different wavelength component of the third wavelength component set.

15. The system of claim 14 wherein the first disperser is operative for apportioning the first wavelength range into a plurality of wavelength bands and dispersing each of the plurality of wavelength bands over the plurality of object points such that the plurality of wavelength bands are substantially co-incident and each of the plurality of object points receives a different portion of each of the plurality of wavelength bands.

16. The system of claim 14 wherein the light source is a swept source that is operative for sweeping the wavelength of the first optical signal through the wavelength range during a first period, T₁, and wherein the first disperser comprises a scanner that is operative for repeatedly scanning the first optical signal over the plurality of object points during each first period, T₁.

17. The system of claim 14 wherein the plurality of detector pixels is arranged in a two-dimensional array.

18. The system of claim 14 wherein the second disperser is operative for dispersing the third wavelength component set along a line.

19. The system of claim 14 wherein the disperser is operative for dispersing the third wavelength component set in two dimensions.

20. The system of claim 14 further comprising a processor that is operative for providing an image of the sample based on the plurality of output signals.
